(19) United States
(12) Patent Application Publication
(10) Pub. No.: US 2002/0128009 A1
(43) Pub. Date: Sep. 12, 2002

(54) Transceiver for fixed wireless access network applications

(76) Inventors: Erik Boch, Dunrobin (CA); Tom Alexander Duxbury, Dunrobin (CA)

Correspondence Address: SMART & BIGGAR, P.O. BOX 2999, STATION D, 55 METCALFE STREET, SUITE 900, OTTAWA, ON, K1P5Y6, CA

(21) Appl. No.: 10/077,914

(22) Filed: Feb. 20, 2002

Related U.S. Application Data
(60) Provisional application No. 60/269,345, filed on Feb. 20, 2001.

(51) Int. Cl. H04Q 7/20

(52) U.S. Cl. 455/426; 455/462; 455/552

(57) ABSTRACT

A combined wireless transceiver and signal conversion unit comprises a radio receiver for receiving a wireless radio signal, and a converter for converting the signal into a form having a communications protocol supported by a communications port of a user digital device. An output device is provided for transmitting the converted signal to a user digital device via a wireline or other suitable medium for carrying the converted signal. The unit includes an input device for receiving a communications signal from the communication port of a user digital device via a wireline or other suitable signal transmission medium, and a transmitter for converting the received signal to a form for wireless transmission.

### FIELD OF THE INVENTION

The present invention relates to a transmitter and receiver for fixed wireless access network applications and in particular but not limited to local multi-point distribution service (LMDS) and multi-channel multi-point distribution service (MMDS) networks.

### BACKGROUND OF THE INVENTION

Wireless communication networks are being deployed to provide digital two-way voice, data, internet and video services to subscribers located within cities, suburban areas and remote areas as an alternative to wireline communication services. Examples of multi-point wireless access systems include local-multi-point distribution service (LMDS) which typically operates at frequencies of between 24 to 31 GHz and 37 to 42 GHz and multi-channel multi-point distribution service (MMDS), which typically operates at frequencies in the range of 2.1 to 7 GHz. These wireless access systems employ fixed, sectorized base stations or central offices which receive communication services from service providers, and other communications by, for example, optical fibre and the public switched telephone network (PSTN) for delivery to service subscribers. The central office or base station includes radio communication equipment to convert the communication signals received over optical fibre and wireline to RF signals, and broadcasts the RF signals to subscribers within its broadcast area. The transmitting antenna of an MMDS base station has a typical range of the order of 35 miles depending on the broadcast power, and that of LMDS typically has a range of between three and five miles.

The customer premises equipment (CPE) comprises an outdoor radio transceiver (ORT) and an associated indoor network termination unit (NTU). The ORT includes outdoor mounted microwave radio transmission and reception equipment (typically antenna and transceiver) and the indoor digital equipment typically includes a tuner for signal modulation/demodulation, control, modem and customer premises interface functionality. Communications between the base station and CPE may be managed using time-division multiple access (TDMA), frequency-division multiple access (FDMA) or code-division multiple access (CDMA) methodologies.

The customer premises interface (indoor unit) generally has the capability of handling a number of communication protocols such as level 0 (DSO), plain old telephone service (POTS), Ethernet, 10BaseT, unstructured DS1, structured DS1, frame relay, ATM 25, serial ATM over T1, DS-3, OC-3 and OC-1. Customer premises may typically include single family units (SFU), multiple dwelling units (MDUs) such as apartment buildings, multiple business units (MBUs) such as office buildings, hospitals, university campuses, factories and shopping centres.

A conventional single family unit CPE configuration for wireless network access is shown in FIG. 1. The customer premises equipment includes a roof-top-mounted outdoor radio transceiver unit (ORT) and antenna 3 for receiving and transmitting wireless radio signals from and to a base station, and a network termination unit (NTU) 5 installed in the basement and connected to the ORT 3 via a coaxial cable 7. The transceiver 3 includes a down-converter for converting the microwave frequency signal to an intermediate frequency (IF) signal which is fed to the NTU via the coaxial cable 7. The NTU 5 includes a demodulator for demodulating the intermediate frequency signal received from the ORT and a modem for converting the demodulated signal and outputting the converted signal onto cable for transmission to one or more computers or data processing units 8, 10 within the household 1. The NTU also includes a modulator for IF modulating signals from the modem for transmission to the ORT 3 via the coaxial cable 7, which are subsequently up-converted by the ORT 3 to microwave frequencies for wireless transmission. The household 1 is also equipped with one or more telephone units 9, 11 which are connected to a central office via an existing POTS line 13. One drawback of this conventional arrangement is that the wireless network equipment requires new indoor wiring 7, 12, 14 to be installed between the ORT and the NTU and between the NTU and the computer terminals. Coaxial cable is expensive and difficult to install and therefore costly to the customer.

A conventional wireless access network installation for a multiple business unit (MBU) is shown in FIG. 2. The system includes a roof-top-mounted outdoor microwave radio transceiver/antenna unit 17 and an indoor network termination unit 19 housed in a secure equipment room 21 in a penthouse 22. The transceiver 17 typically includes a down-converter for converting the received microwave frequency signals to IF frequencies for transmission over coaxial cable 23 to the indoor unit 19. The transceiver 17 also includes an up-converter for converting IF frequency signals from the indoor unit 19 to microwave frequencies for wireless transmission. The indoor unit is connected to a CPE router 25, installed in a switching room 26 in the basement 27 of the MBU, via a riser cable 29, which is installed in the riser shaft 31 of the building 2. The indoor unit 19 typically includes a signal demodulator for demodulating the IF signal and a signal converter for converting the demodulated signal into signals having the desired transmission protocols for transmission to customers' data processing units on individual floors of the building via the CPE router 25, and drop cables 33, 35, 37 which carry the signals to different floors of the building. A disadvantage of this conventional installation is that it requires one or more secure fitted equipment rooms for the indoor network termination units, together with one or more power supply systems for providing power to the indoor units.

An example of a radio local loop system having a radio link between a base station and a subscriber station is described in U.S. Pat. No. 5,802,177 (Daniel, et al). The radio loop equipment at the subscriber station includes an intelligent telephone socket which is situated indoors within the subscriber's building at a convenient location for connection to subscriber's equipment and has call processing and speech transcoding/encryption circuitry and an interface for connection to subscriber's equipment, and a subscriber transceiver unit which is situated close to the radio antenna and includes a modem and radio frequency apparatus, and a serial base-band link connecting the subscriber transceiver unit to the intelligent telephone socket.

U.S. Pat. No. 5,774,789 (van der Kaay, et al) discloses an RF communication signal distribution system for relaying mobile telecommunication signals within an office building. The system includes a cellular transceiver, connected to a roof-top-mounted antenna, a signal processing subsystem for down-converting received RF communication signals and transmitting the down-converted signals over a twisted pair cable to a second signal processing subsystem. The second signal processing subsystem includes a transceiver which up-converts the signals received over the twisted pair and transmits the up-converted signals via a local antenna housed within the building for reception by mobile telephones. The transceiver also receives signals from in-building mobile telephones and down-converts the signals for transmission over a second twisted pair to the first signal processing subsystem which up-converts the signal and passes the signal to the cellular transceiver for broadcast outside the building by the roof-top-mounted antenna.

### SUMMARY OF THE INVENTION

According to the present invention, there is provided a combined wireless radio transceiver and signal conversion unit for use in a wireless network access communication system, the unit including: a combined wireless transceiver and signal conversion unit comprising a radio receiver for receiving a wireless radio signal, a converter for converting the signal into a form having a communications protocol supported by a communications port of a user digital device, and an output for outputting the converted signal, an input device for receiving a communications signal from the communication port of a user digital device and a transmitter for converting the received signal to a form for wireless transmission.

Advantageously, this arrangement provides a single wireless access network unit, which may be conveniently mounted on the outside of a building, and which receives wireless radio signals (for example in the microwave frequency range) and converts the incoming signals to a form which can be transmitted over a local communications link, e.g. the internal wiring of the building, to the appropriate user digital device or customer data processing unit(s). The single unit can therefore reduce the cost of a wireless network installation as compared to the conventional approach which employs at least one outdoor mounted radio transceiver and at least one indoor network termination unit. Advantageously, the single combined wireless radio transceiver and signal conversion unit can be adapted to connect directly to existing in-building wiring, thereby obviating the need for new wiring which adds to the installation costs.

In a preferred embodiment, the unit includes management means to manage functions of the radio transceiver section. Advantageously, the proximity of the signal conversion section to the radio transceiver section facilitates management of transceiver functions in comparison to the prior art arrangement in which management of the outdoor transceiver unit by the indoor network termination unit would be limited or precluded altogether due to the data and protocol traffic density imposed on the coaxial cables carrying communications between the two. Moreover, the single unit approach of the present invention improves reliability of the system due to the reduced complexity and number of components of the equipment required as compared to the conventional approach.

Also in accordance to the present invention, there is provided a combined wireless transceiver and signal conversion unit comprising a radio receiver for receiving a wireless radio signal, a converter for converting the signal to a form suitable for reception by a communications port of a user digital device, and an output for outputting the converted signal, an input device for receiving a communications signal from a communications port of a user digital device, the input device being adapted to support the communications protocol of communication signals from the communications port of a user digital device and a transmitter for converting the signal to a form for wireless transmission.

According to the present invention, there is further provided a combined wireless receiver and signal conversion unit comprising a radio receiver for receiving a wireless radio signal, a converter for converting the signal into a form having a communications protocol supported by a communications port of a user digital device, and an output for outputting the converted signal, an input device for receiving a communications signal from the communication port of a user digital device and a transmitter for converting the received signal to a form for wireless transmission.

According to the present invention, there is further provided a combined wireless radio transmitter and signal conversion unit for use in a communications system comprising an interface device capable of reading communication signals having a form output from subscriber terminating equipment and a wireless radio transmitter, the interface device being arranged to convert the received signal into a signal suitable for transmission by the transmitter, the transmitter being arranged to transmit the signal received from the interface device as a wireless radio signal.

Further advantageous features of embodiments of the present invention are described and defined hereinbelow.

### BRIEF DESCRIPTION OF THE DRAWINGS

Examples of embodiments of the present invention will now be described with reference to the drawings in which:

FIG. 1 shows a schematic diagram of a conventional wireless network access equipment installation in a single family unit, according to the prior art;

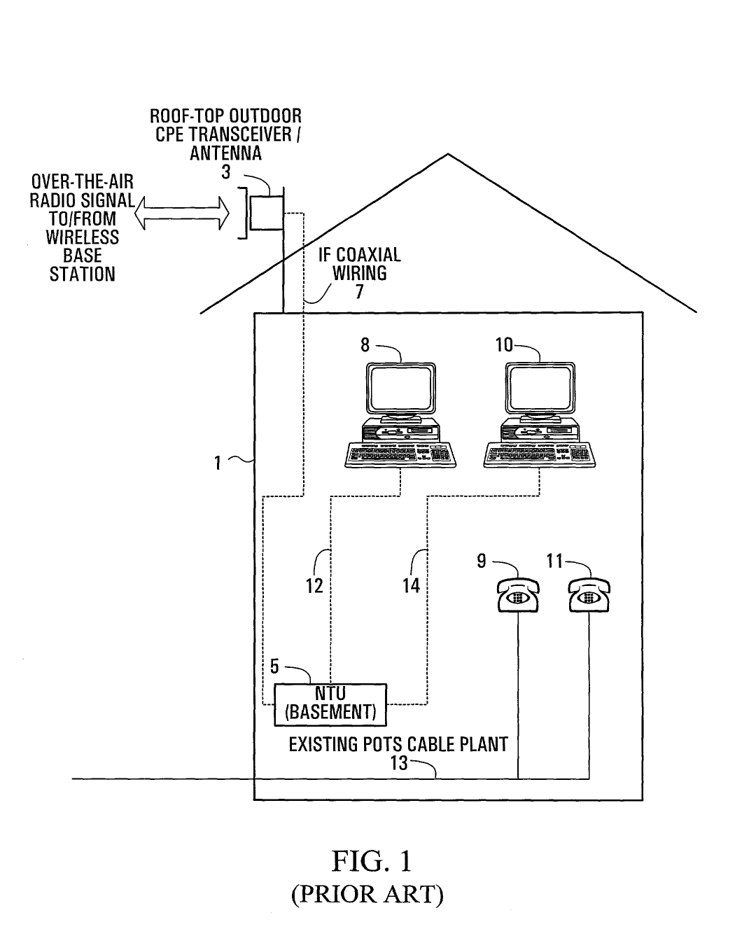

FIG. 2 shows a wireless network access equipment installation in a multiple business unit, according to the prior art;

FIG. 3 shows a schematic diagram of an embodiment of the present invention;

FIG. 4 shows an example of an embodiment of the present invention installed in a single family unit;

FIG. 5 shows an example of an embodiment of the present invention installed in a building;

FIG. 6 shows an example of an embodiment of the present invention installed in a multiple business or dwelling unit;

FIG. 7 shows a block diagram of an embodiment of the present invention; and

FIG. 8 shows an example of an application of the embodiment of FIG. 7.

### DETAILED DESCRIPTION OF PREFERRED EMBODIMENTS

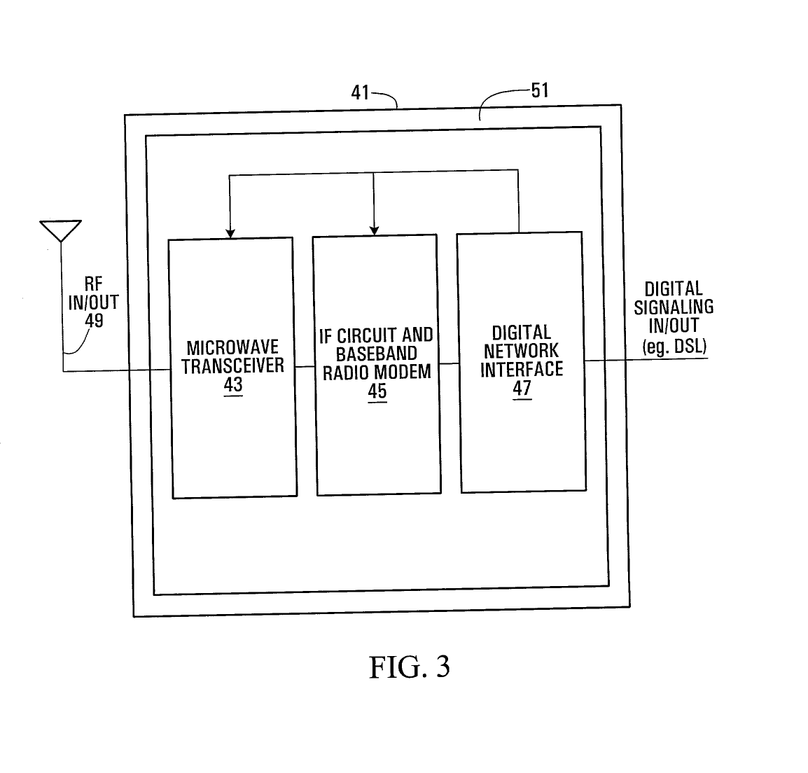

FIG. 3 shows a communication signal conversion unit according to one embodiment of the present invention. Referring to FIG. 3, the unit 41 comprises a microwave transceiver 43, an intermediate circuit and baseband radio modem 45 and a digital network interface 47. The microwave transceiver 43 receives microwave communication signals via the microwave antenna 49 and includes a down-converter (not shown) for down-converting the received microwave frequency signal to an intermediate frequency signal which is then passed to the IF circuit and baseband radio modem 45. The microwave transceiver 43 also includes an up-converter (not shown) for up-converting intermediate frequency communication signals generated by the IF circuit and baseband radio modem 45 to microwave frequencies for wireless transmission by the microwave antenna 49. The IF circuit and baseband radio modem 45 includes a demodulator (not shown) for demodulating the IF signal received from the microwave transceiver 43 and means for processing the demodulated signal to remove wireless transmission control data (e.g. signal overhead) contained within the signal. The IF circuit and baseband radio modem 45 also includes means for generating a signal containing digital data received for wireless transmission from the digital network interface 47 together with signal transmission control data for controlling functions of the remote base station receiver to which the data is to be transmitted, and a signal modulator for modulating the generated signal to immediate frequencies which is subsequently passed to the microwave transceiver 43.

The digital network interface 47 receives processed signals from the IF circuit and baseband radio modem 45 containing the original information data, and from which the wireless transmission control data has been removed, and converts the signal into a form which is suitable for reception by subscriber equipment of the kind for which the information data contained within the signal is intended, for example a telephone, a pager, a computer (e.g. PC, workstation or server), a TV or any other static or portable device having a communication capability.

In the present embodiment, the digital network interface 47 includes means for generating a digital subscriber line (DSL) formatted signal (e.g. DSL, Asymmetric Digital Subscriber Line (ADSL), High Data Rate Digital Subscriber Line (HDSL), Symmetric Digital Subscriber Line (SDSL), Very High Data Rate Digital Subscriber Line (VDSL)) which, advantageously, is suitable for transmission over a twisted pair cable. Since most existing buildings are already wired with twisted pair cables for telephone communications, the communication signal conversion unit 41 can be connected directly to the existing wiring. Twisted pair cables are also likely to run near rooftop levels and therefore near the location where the unit 41 is intended to be mounted, thereby obviating the need for substantial new wiring and, in particular, coaxial cable between the antenna and the network termination unit (NTU) housed in the basement, which is required by the conventional installation methodology. Although the unit 41 may include one or more interfaces which support any local communication protocol(s), embodiments of the unit which include a DSL interface, advantageously exploit this high speed wireline link methodology which is ideally suited to in-building transmission distances.

Furthermore, as the signal output from the communication signal conversion unit 41 is suitable for direct reception by one or more subscriber data processing units, a separate conventional network termination unit, as disclosed in U.S. Pat. No. 5,082,177, mentioned above, is not required. The unit 41 also simplifies the circuitry of the approach disclosed in U.S. Pat. No. 5,802,177 by removing the need for interface circuitry in the outdoor and indoor units which enable them to communicate between each other. As the unit 41 can be implemented with fewer components than that the prior art approach, improved reliability and reduced cost advantages can be obtained. Furthermore, integrating the microwave transceiver and the IF circuit and radio modem into a single unit eliminates the need to match the conventional transceiver unit with the network termination unit (NTU) and removes the inflexibility of conventional installations due to the limited choice and possible combinations of transceiver and NTU devices resulting from the need to match the two units.

Preferably, the unit 41 includes a monitor for monitoring functions of the microwave transceiver 43 and for communicating the monitored functions to the microwave radio receiver station with which it communicates. Advantageously, malfunctions or changes in operation of the microwave transceiver can be communicated to the receiver station which is important for network management. Preferably, the unit 41 also includes means for controlling functions of the microwave transceiver and communicating related information to the receiver station, as necessary. The unit 41 may include means for managing and/or controlling functions of the IF circuit and baseband radio modem. As mentioned above, management and control of the microwave transceiver unit in the conventional installation requiring coaxial cable between the transceiver unit and the NTU is either limited or absent altogether.

The unit 41 preferably includes a casing or housing 51 enclosing the transceiver 43, the IF circuit and baseband radio modem 45 and the digital network interface 47. The casing 51 preferably comprises a water resistant material and is appropriately sealed to prevent the ingress of water and/or other fluids such as air.

In one embodiment, a component of at least two of the transceiver 43, the IF circuit and baseband radio modem 45 and the digital network interface 47 are placed on the same circuit board.

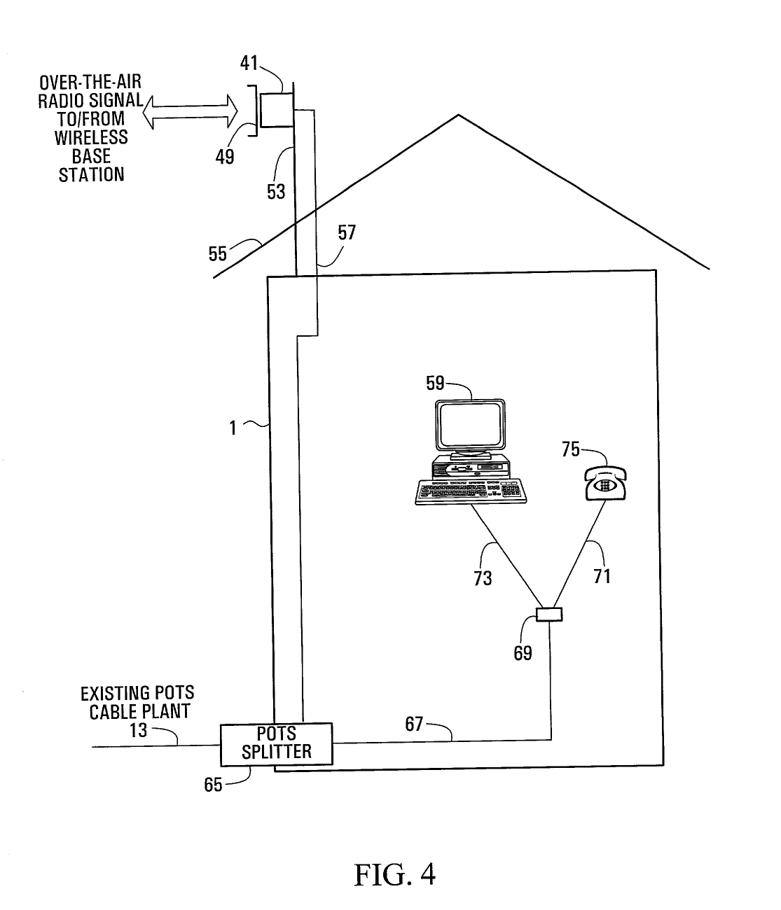

FIG. 4 shows an example of an installation of an embodiment of the communication signal conversion unit at a single family unit (SFU) 1. A microwave antenna 49 and a communication signal conversion unit 41 are mounted at an elevated position on the outside of the building 1, for example on a pole or mast 53 extending upwardly from the roof 55. A wireline 57, which may comprise a twisted pair cable, is connected to the output of the communication signal conversion unit 41 for carrying communication signals between the communication signal conversion unit 41 and subscriber equipment, such as one or more computers 59 and/or other communication devices. The wireline 57 may be connected to a convenient junction or terminal of the existing wireline (e.g. telephone line) network within the building. In this example, the building receives a conventional wireline telephone service 13 and is provided with a POTS splitter 65 to which the external POTS cable 13 and the wireline 57 from the communication signal conversion unit 41 are connected. The existing internal wiring 67 of the building, used for telephone and computer (e.g. internet) communications is also connected to the POTS splitter 65. The other end of the wireline 67 may terminate at a conventional telephone socket 69 installed in a room in the building, into which may be plugged appropriate wires 71, 73 for a telephone 75 and a computer 59. The POTS splitter 65 serves to separate voice-band signals originating from the telephone 75 from data communication signals from the computer 59 and place the telephone signals on the external POTS wireline 13 and the data communication signals from the computer 59 onto the wireline 57 for transmission to the roof-top-mounted communication signal conversion unit 41 for wireless transmission to the receiver station.

Wireless signals received by the communication signal conversion unit 41 are converted to a form both suitable for transmission over the internal wiring of the building and having a protocol format which is supported and suitable for direct reception by the communication port of the computer or other digital communication device. For example, the signal conversion unit may convert the signal into a DSL format, for example ADSL or VDSL. The signal output by the signal conversion unit 41 is passed through the POTS splitter 65 onto the internal wiring 67 of the building and to the computer 59. Incoming telephone calls on the external POTS wireline are passed through the POTS splitter 65 and again onto the internal wiring 67 of the building to the telephone 75.

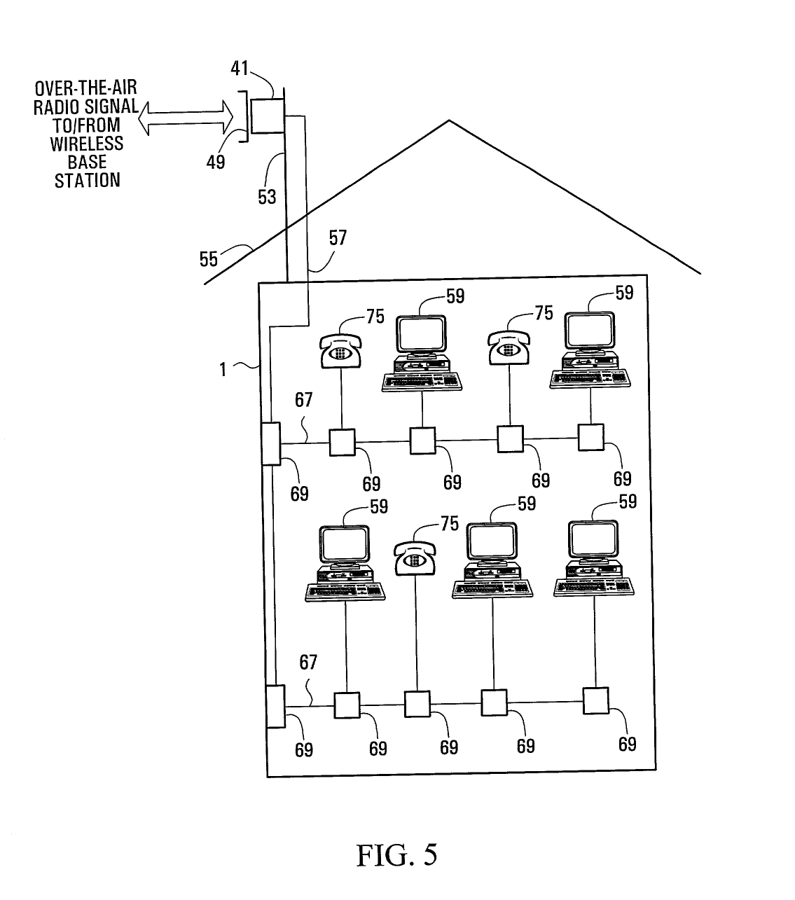

FIG. 5 shows an example of an installation where the communication signal conversion unit is used for wireless telephony and wireless data communication where, for example, a conventional POTS service is not provided or a wireless alternative is required. The communication signal conversion unit 41 receives both telephone and data communication signals from a remote base station. The conversion unit 41 includes signal separation means (not shown) which separates the telephone signals and data communication signals and signal converter means which converts the signals into a form, ie. having a transmission protocol, which is supported by the subscriber's telephone and computer equipment. For example, the conversion unit 41 may output both voice band telephone signals for the telephone equipment and DSL signals for the computer equipment onto a common wireline 57, for example, a twisted pair cable connected to the internal wiring or local area network (LAN) 67 of the building 1. The internal wireline or LAN 67 may include one or more sockets 69 into which one or more computers and/or telephones 75 and/or other communication equipment may be plugged. The cable 57 from the signal conversion unit 41 may be conveniently connected to the internal wireline 67 via a socket 69. In other embodiments, cable 57 and internal cabling 67 may comprise optical fibre or coaxial cable or other cable for supporting other forms of signal and transmission protocol.

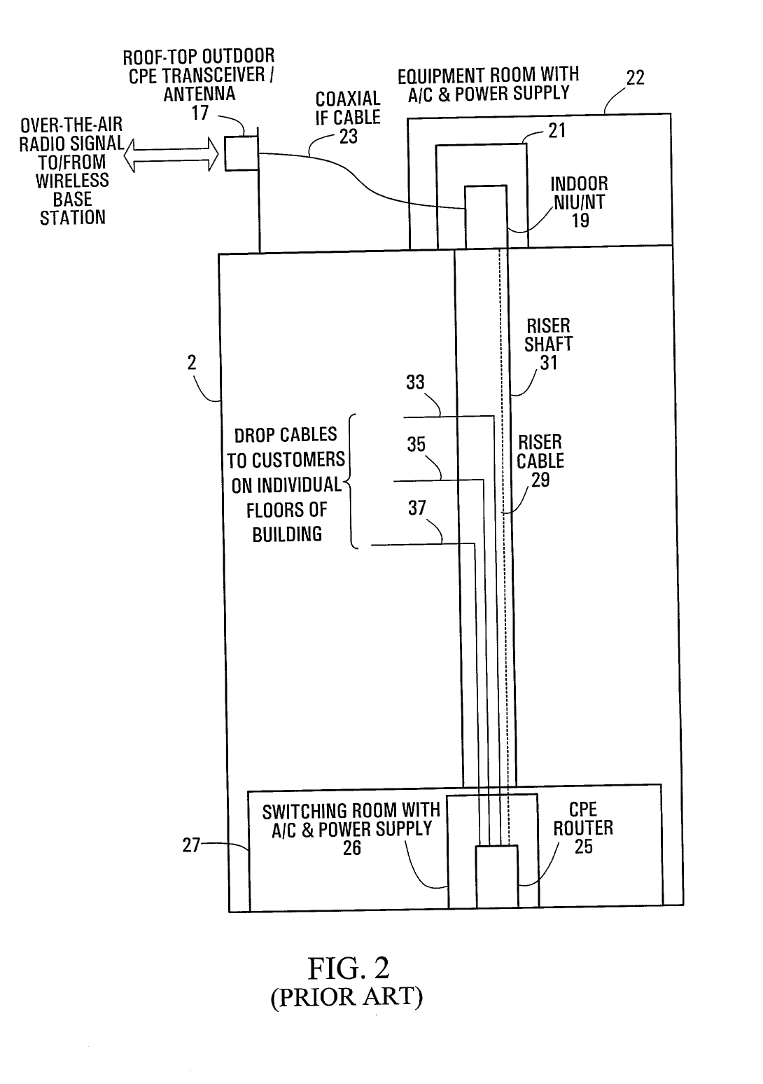

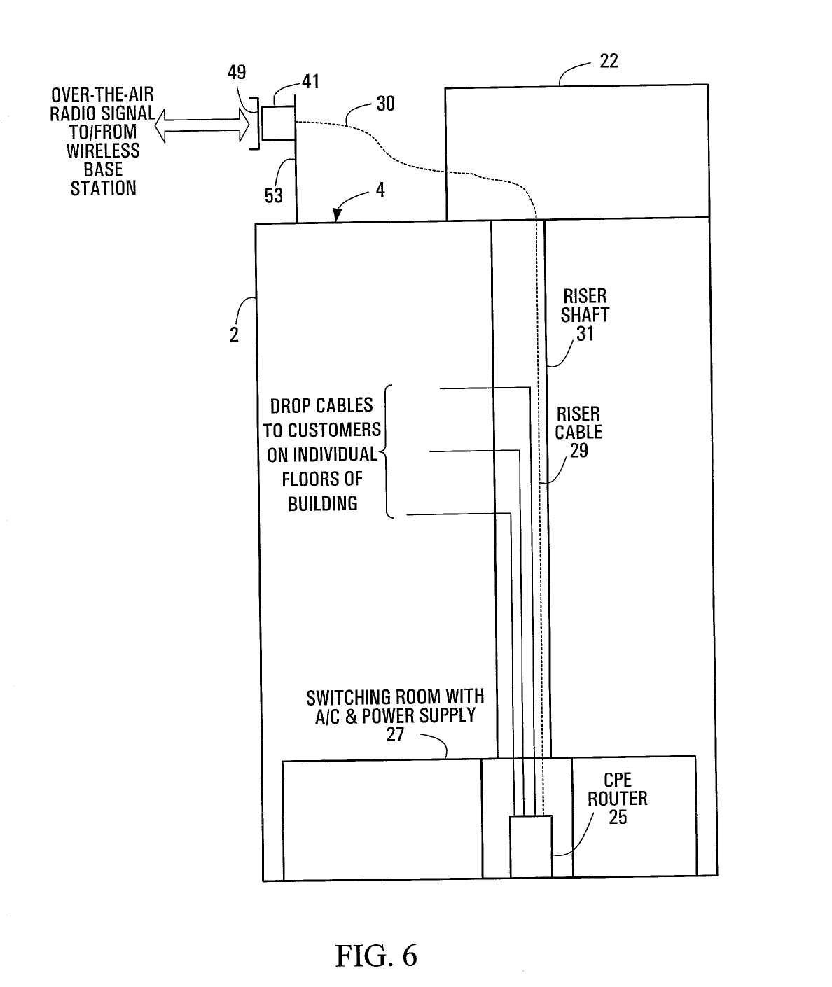

FIG. 6 shows an example of an embodiment of a communication signal conversion unit serving a multiple dwelling unit (MDU) or a multiple business unit (MBU). A microwave antenna 49 and signal conversion unit 41 are mounted at an elevated position on the building 2 and, in the present example, are mounted on a mast or pole 53 extending from the top 4 of the building 2. The microwave antenna 49 is preferably positioned so as to have direct line of sight with the antenna of its associated base station (not shown). The communication signal conversion unit 41 may be adapted to convert received data communication signals into DSL formatted signals for wireline transmission to equipment at different customer premises within the building via the CPE router 25. In this example, the signal conversion unit 41 is conveniently connected to the existing internal riser cable 29 via an extension cable 30. The existing riser cable 29 may comprise for example a twisted pair cable for telephone communications and/or one or more other types of cable. In comparison to a conventional installation, as shown in FIG. 2, the conversion unit 41 in the installation of FIG. 6 advantageously removes the need for a separate indoor network interface/termination unit 19 and a secure equipment room 21 for housing the unit 19. Equipment rooms at the top of many multiple dwelling and business units house electrical equipment such as electrical elevator motors which act as a source of electrical and RF noise and interference to communication equipment. Advantageously, the present communication signal conversion unit may be mounted at a location remote from such noise sources, thereby improving reliability and communication signal fidelity over conventional installations which require an indoor network termination unit. These equipment rooms are also often cramped and leave very little space for the installation of new equipment. Advantageously, embodiments of the signal conversion unit can be mounted outside, elevating the need for and cost of inside space.

Embodiments of the communication signal conversion unit may include a digital network interface which is capable of interfacing with subscriber equipment which communicates using two or more different communication protocols and/or transmission media. For example, the interface may be adapted to handle transmission protocols such as digital subscriber line, e.g. DSL, SDSL, ASDL, VDSL, Home Phoneline Network Alliance (HPNA), AC powerline networking, IEEE 1394-1995 “Firewire” and localized wireless networks such as Bluetooth and IEEE 802.11. For example, in the case of a localized wireless network, the communication signal conversion unit would convert the received microwave frequency signals and generate and transmit appropriate wireless signals for the local wireless network according to the appropriate protocol. In this case, no wiring would be required between the communication signal conversion unit and subscriber communication devices within the building.

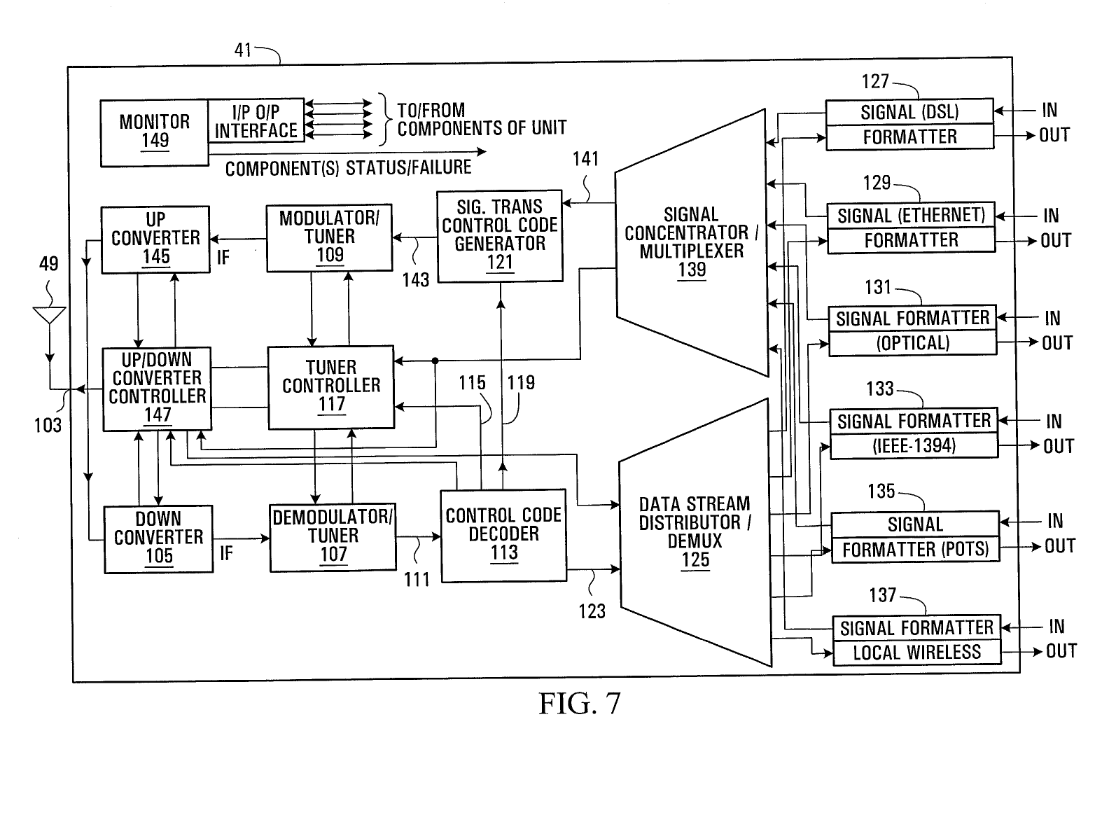

FIG. 7 shows a block diagram of an embodiment of a communication signal conversion unit which is capable of interfacing with subscriber equipment which communicates, using different communication protocols. The unit is capable of receiving data embedded in a wireless communication signal, separating the data according to the transmission scheme by which the data is intended to be conveyed to subscriber equipment, reformatting the data according to the appropriate transmission scheme protocol and transmitting the data onto the appropriate local i.e. CPE transmission media, for example wireline (twisted pair, coaxial cable, power cable or other cable/wireline), optical fibre or local wireless. The unit is also capable of receiving data output from subscriber equipment according to a number of different data transmission schemes and embedding the data into an RF signal for wireless transmission to a base station or central office serving the wireless network.

The signal conversion unit 41 shown in FIG. 7 comprises an RF signal input/output port 103 which receives microwave frequency communication signals from the antenna 49. The incoming microwave frequency signals are passed from the input port 103 to a down-converter 105 which converts the microwave frequency signal to a lower, intermediate frequency (IF) signal which is passed to a demodulator/tuner 107. The demodulator/tuner 107 demodulates the IF signal and outputs data, for example, in a serial bit stream 111 (or other format) containing the original digital data intended for one or more subscribers, wireless transmission control code for controlling functions of the receiver-tuner 107 (e.g. for tuning to the correct channel on instruction from the base station), control code for the transmitter-tuner 109 (e.g. for tuning the transmitter-tuner to the correct channel on direction from the base station), data identifying the local subscriber transmission scheme over which the information data is to be sent, and data identifying the subscriber equipment to which the information data is to be sent. The serial bit stream 111 is passed to a tuner control code decoder 113 which removes the control code for controlling tuning functions from the serial bit stream 111 and also removes other control code required for controlling wireless transmission between the base station and the CPE transceiver 41, for example, communication acknowledgement messages. Tuner control code 115 is passed from the tuner control code decoder 113 to the tuner controller 117, which controls functions of the receiving and transmitting tuners 107, 109 in response to the control code. Other wireless communication control code is also removed by the tuner control code decoder 113 and passed to a signal transmission control code generator 121 which generates appropriate acknowledgement messages and control codes for transmission to the base station.

The control code decoder 113 outputs the serial bit stream 123, with tuning control code and other wireless transmission control data removed, and passes the serial bit stream 123 to a data packet/cell distributor 125. The data packet distributor 125 identifies from identification data in the serial bit stream, the local transmission scheme on which each information data packet or cell is to be transmitted, and forwards each data packet/cell to the appropriate transmission scheme formatter. The data packet distributor 125 may remove the transmission scheme identification data before forwarding the information data to the appropriate formatter, thereby preventing unwanted transmission overhead from further transmission. Alternatively, the transmission scheme identification data may be received by the formatter to which the packet is directed. In either case, removal of ID data allows an increase in the information data transmission density over the local transmission medium. Data packets containing the information data and, for example, a header identifying the destination subscriber equipment is formatted according to the appropriate protocol for transmission over the appropriate local transmission medium or network.

By way of example only, the signal conversion unit 41 illustrated in FIG. 7 has a number of formatters for different transmission schemes, including an XDSL formatter 127, which may comprise any one or more of DSL, ADSL, SDSL, VDSL and HDSL as well as others, an Ethernet formatter 129 which may comprise any one or more of 10BaseT, 10Base5, 10Base10-2, 100Base-T and Gigabit Ethernet as well as others, an optical formatter 131 which may include optical transmission schemes, such as OC1 and/or OC3 or other scheme, an IEEE 1394-1995 “Firewire” formatter 133, a plain old telephone service (POTS) formatter 135 and a local wireless transmission formatter 137 using one or more transmission schemes such as “Bluetooth”. In other embodiments, unit 41 may be adapted for use with more or fewer transmission schemes (e.g. one or more than one) and may include different transmission schemes such as digital TV, home phoneline network alliance (HPNA), T1/T3, IBM token ring network protocol and AC powerline, as well as others.

Data to be sent from subscriber equipment over the wireless link to the base station is transmitted from the communication port of the subscriber device (e.g. computer) over the local transmission medium to which it is connected and according to the local transmission protocol, to the appropriate signal formatter 127 to 137 of the digital network interface of the signal conversion and transmission unit 41. The formatters may remove transmission management and control code required in the communication protocol of the local transmission schemes between the signal conversion unit 41 and the subscriber equipment and forward data packets containing destination and information data to a data packet concentrator/multiplexer 139.

The concentrator/multiplexer 139 is connected to receive data from each of the formatters 127 to 137 and places the data packets into, for example, a serial bit stream 141. The concentrator/multiplexer 139 may be adapted or controlled to determine the particular order in which data packets from each of the formatters are placed into the serial bit stream, for example according to one or more factors such as traffic density, the spare capacity of its input buffer(s), and priority of service and/or data. The serial bit stream 141 output from the concentrator/multiplexer 139 is passed to the signal transmission control code generator 121 which adds transmission control code to the serial bit stream for controlling wireless transmission between the transceiver unit 41 and the base station. The encoded serial bit stream 143 from the signal transmission control code generator 121 is then passed to the transmitter-modulator/tuner 109 in which the digital signal modulates an IF signal which is subsequently up-converted by the up-converter 145 to the microwave transmission frequencies of the wireless network and output from the RF signal input/output port 103 to the antenna 51 for wireless transmission to the base station.

The signal transmission and conversion unit 41 preferably includes a controller 147 for controlling functions of the down-converter 105 and the up-converter 145. For example, the converter controller 147 may control functions of the mixer, oscillator and/or the amplifier in the up and/or down-converter circuits, as well as other functions. Control signals for the converter controller 147 may be transmitted from the base station, for example, on the data communication channel and intercepted and passed to the converter controller 147 by the tuner control code decoder 113. Alternatively, or in addition, control signals from the base station for the converter controller 147 and/or for the tuner controller 117 may be sent on a separate wireless control channel and may comprise either analogue or digital signals. Control signals for the converter controller 147 may also be derived from the tuner controller 117 and/or vice versa, so that at least one of the converters and modulator/demodulator are controlled in response to the other. Alternatively, or in addition, control signals for the tuner controller 117 and/or the converter controller 147 may be transmitted from a device at the customer premises for example on one or more of the transmission media over which the signal conversion and transmission unit 41 communicates. For example, control signals for the tuner controller 117 and/or the converter controller 147 may be sent over the DSL, or Ethernet or any other transmission media from a computer.

The converter controller 147 and/or the tuner controller 117 may include monitor means for monitoring functions and/or the condition of the up-converter circuit 145 and/or the down-converter circuit 105, and/or the transmitter-tuner 109 and/or the receiver-tuner 107, and/or other components of the unit, or a monitor 149 may be provided for this purpose. The converter controller 147 and/or the tuner controller 117 or monitor 149 may be adapted to transmit signals indicative of the condition of the converter and tuner circuits, or other circuit or a component thereof, to the base station and/or to monitoring equipment at the customer premises. For example, the monitoring means or monitor 149 may monitor the condition, any malfunctions, stability, temperature, and/or age of components such as the amplifier, local oscillator, gain controller, and/or mixer and/or the stability of the power supply. Signals indicative of the condition of the converters and/or tuners and/or other components of the unit may be generated by the respective controller 117, 147 or monitor 149 and transmitted over the wireless link to appropriate wireless transmission management equipment at the base station or central office, which could then take appropriate action, for example, by transmitting converter and/or tuner control signals to the signal conversion unit 41. If for some reason the transmission circuitry of the unit 41 fails so that wireless transmission is not possible, an indication of this failure may be transmitted on an alternative media, for example by a PSTN wireline from the customer premises to the base station if such an alternative exists. Thus, it can be seen that the integrated unit 41 facilitates monitoring, management and control of the wireless transmission circuitry, as well as its other circuitry and can provide this information to its associated base station to better enable network management.

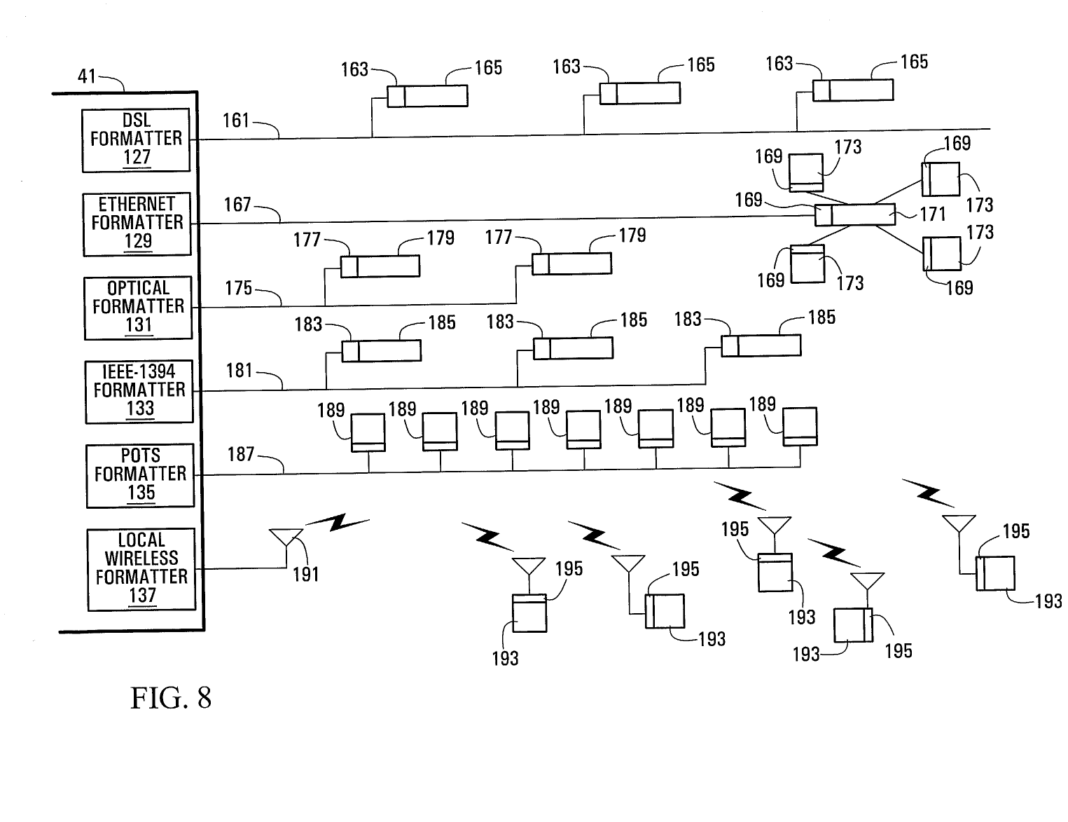

FIG. 8 shows an example of customer premises communication networks/media to which the communication signal conversion unit 41 shown in FIG. 7 may be connected.

The DSL formatter 127 is connected to a twisted pair cable line or network 161 to which is connected one or more communication port(s) 163 which support DSL communications of one or more devices 165. Ethernet formatter 129 is connected to an Ethernet transmission line or network 167 (e.g. twisted pair cable or coaxial cable), to which the Ethernet port/interface 169 of one or more computer server 171 is connected. In this example, a number of computing or other devices 173 are connected to the server 171 and may also communicate with the server 171 using an Ethernet transmission scheme. In this example, the computing devices 171, 173 are connected in a star configuration.

An optical formatter 131 of the signal conversion unit 41 is connected to an optical transmission line 175. The optical interface(s) 177, which support the local optical transmission protocol, of one or more devices 179 are connected to the optical transmission line 175.

An IEEE 1394-1995 “Firewire” formatter 133 of the signal conversion unit 41 is connected to a transmission line or network 181 which supports the IEEE 1394 transmission scheme. The communication port/interface 183 which supports the IEEE 1394 communication protocol of one or more devices 185 is connected to the transmission line 181.

The POTS formatter 135 of the signal conversion unit 41 is connected to a POTS line or network 187 to which is connected one or more telephones 189.

The local wireless formatter 137 of the signal conversion unit 41 is connected to a local antenna 191 which may be located adjacent the unit and either inside or outside the building. The local wireless formatter 137 generates a signal containing data to be conveyed over the local wireless network to one or more devices 193 each having a communication port/interface 195 which supports the local wireless transmission protocol (e.g. Bluetooth).

Although in the embodiment of FIG. 8, each formatter of the signal conversion unit 41 is shown to be connected to a different transmission medium for different communication schemes, in other embodiments, two or more formatters may be connected to the same communication transmission medium, if the medium supports the transmission schemes. In this case, a multiplexer or other signal controller may be required to control sharing of the transmission medium by the different transmission schemes.

In any of the embodiments described above, as well as other embodiments, the signal conversion unit may be adapted to process signals derived from either one or both LMDS and MMDS networks.

In any of the embodiments described herein, the unit 41 may be installed inside a building. The antenna may also be installed inside the building—e.g. in the roof space depending on the strength and quality of the wireless signal reception.

The signal conversion unit 41 described herein is provided by way of example only. It will be appreciated that it is possible to implement numerous alternative configurations, for example having one or more different features and/or components.

In other embodiments, the signal conversion unit may be adapted to receive and transmit wireless signals to the base station using different antennas, i.e. one for receiving, the other for transmitting.

The signal conversion unit may be adapted to receive wireless signals on two or more channels simultaneously and/or transmit wireless signals on two or more channels simultaneously.

In other embodiments, the signal conversion unit may be adapted to convert in parallel simultaneously received signals from the base station side or the customer premises side.

In other embodiments of the signal conversion unit, means may be provided to remove or add a wireless carrier in one step, i.e. without the need for IF modulation/demodulation.

Although it is preferred that the signal conversion unit is implemented as a transceiver, in other embodiments, the unit may be implemented only as a receiver or a transmitter of wireless signals.

Although embodiments of the wireless receiver/transmitter have been described with reference to microwave frequencies, embodiments of the invention may be implemented for use with any other suitable RF frequencies.

Any of the features described herein in connection with one embodiment may be combined with any one or more features described herein in connection with another embodiment.

Modifications to any of the embodiments described above will be apparent to those skilled in the art.

1. A combined wireless transceiver and signal conversion unit comprising a radio receiver for receiving a wireless radio signal, a converter for converting the signal into a form having a communications protocol supported by a communications port of a user digital device, and an output for outputting the converted signal, an input device for receiving a communications signal from the communication port of a user digital device and a transmitter for converting the received signal to a form for wireless transmission.

2. A combined wireless transceiver and signal conversion unit as claimed in claim 1, wherein said input device is adapted to support the communications protocol of communication signals from the communications port of a user digital device.

3. A combined wireless transceiver and signal conversion unit as claimed in claim 1 wherein said converter and input device are adapted to support the same communications protocol supported by a communications port of a user digital device.

4. A combined wireless radio transceiver and signal conversion unit as claimed in claim 1, wherein at least one of the converter and the input device is adapted to convert a signal it receives for transmission into a digital subscriber line formatted signal.

5. A combined transceiver and signal conversion unit as claimed in claim 4, wherein at least one of the signal converter and the input device is adapted to convert the received signal into any one or more of an Asymmetric Digital Subscriber Line (ADSL), a Symmetric Digital Subscriber Line (SDSL), a High Data Rate Digital Subscriber Line (HDSL) and a Very High Data Rate Digital Subscriber Line (VDSL)formatted signal.

6. A combined wireless radio transceiver and signal conversion unit as claimed in claim 1, wherein at least one of said converter and input device are adapted to support at least one of an Ethernet communications protocol, an optical signal communications protocol, an IEEE 394-1995 communications protocol, a plain old telephone service (POTS) communications protocol, a local wireless communications protocol, a Home Phone Line Network Alliance (HPNA) communications protocol, an AC power line communications protocol and an IBM token ring network communications protocol.

7. A combined wireless radio transceiver and signal conversion unit as claimed in claim 1, wherein said radio receiver comprises a down-converter for converting the received radio signal to an intermediate frequency signal.

8. A combined wireless radio transceiver as claimed in claim 7, further comprising a tuner for demodulating the intermediate frequency signal.

9. A combined wireless radio transceiver and signal conversion unit as claimed in claim 1, further comprising a tuner for demodulating the received radio signal.

10. A combined wireless radio transceiver and signal conversion unit as claimed in claim 1, wherein said transmitter comprises a modulator for modulating a communications signal received from said input device.

11. A combined wireless radio transceiver and signal conversion unit as claimed in claim 10, further comprising an up-converter for up-converting the signal from said modulator to the desired wireless transmission frequency.

12. A combined transceiver and signal conversion unit as claimed in claim 1, further comprising a monitoring device for monitoring a status of at least one of the radio receiver, radio transmitter and another component of said unit, and for outputting a signal representative of the monitored status.

13. A combined transceiver and signal conversion unit as claimed in claim 12 wherein said monitoring device is adapted to output the signal representative of the monitored status as a radio signal from said transmitter.

14. A combined wireless radio transceiver and signal conversion unit as claimed in claim 12, wherein said monitoring device is arranged to output a signal representative of the monitored status via said output to a user digital device.

15. A combined transmitter and signal conversion unit as claimed in claim 12, wherein said status comprises a function of said receiver and/or transmitter and/or a parameter indicative of a condition of said receiver/transmitter and/or a characteristic of said receiver and/or transmitter.

16. A combined wireless transceiver and signal conversion unit comprising a radio receiver for receiving a wireless radio signal, a converter for converting the signal to a form suitable for reception by a communications port of a user digital device, and an output for outputting the converted signal, an input device for receiving a communications signal from a communications port of a user digital device, said input device being adapted to support the communications protocol of communication signals from the communications port of a user digital device and a transmitter for converting the signal to a form for wireless transmission.

17. A combined wireless transceiver and signal conversion unit as claimed in claim 16, wherein said converter is adapted to convert the received signal into a form having a communications protocol supported by a communications port of a user digital device.

18. A combined wireless transceiver and signal conversion unit as claimed in claim 16, wherein said converter and input device are adapted to support the same communications protocol supported by a communications port of a user digital device.

19. A combined wireless radio transceiver and signal conversion unit as claimed in claim 16 wherein at least one of the converter and the input device is adapted to convert a signal it receives for transmission into a digital subscriber line formatted signal.

20. A combined transceiver and signal conversion unit as claimed in claim 19, wherein at least one of the signal converter and the input device is adapted to convert the received signal into any one or more of an Asymmetric Digital Subscriber Line (ADSL), a Symmetric Digital Subscriber Line (SDSL), a High Data Rate Digital Subscriber Line (HDSL) and a Very High Data Rate Digital Subscriber Line (VDSL)formatted signal.

21. A combined wireless radio transceiver and signal conversion unit as claimed in claim 16, wherein at least one of said converter and input device are adapted to support at least one of an Ethernet communications protocol, an optical signal communications protocol, an IEEE 1394-1995 communications protocol, a plain old telephone service (POTS) communications protocol, a local wireless communications protocol, a Home Phone Line Network Alliance (HPNA) communications protocol, an AC power line communications protocol and an IBM token ring network communications protocol.

22. A combined transceiver and signal conversion unit as claimed claim 16, further comprising a monitoring device for monitoring a status of at least one element of said combined transceiver and signal conversion unit, and for outputting a signal representative of the monitored status.

23. A combined transceiver and signal conversion unit as claimed in claim 22, wherein said status comprises a function of said receiver and/or transmitter, and/or a parameter indicative of a condition of said receiver/transmitter and/or a characteristic of said receiver and/or transmitter.

24. A combined transceiver and signal conversion unit as claimed in claim 22, wherein said at least one element comprises at least one of the radio transmitter and the radio receiver.

25. A combined transceiver and signal conversion unit as claimed in claim 22 wherein said monitoring device is adapted to output the signal representative of the monitored function as a radio signal from said transmitter.

26. A combined wireless radio transceiver and signal conversion unit as claimed in claim 22, wherein said monitoring device is arranged to output a signal representative of the monitored function via said output to a user digital device.

27. A combined wireless transceiver and signal conversion unit as claimed in claim 16, wherein said converter is adapted to convert a received radio signal having a first communications protocol for wireless communications between the transceiver and a transmitter with which it is adapted to communicate into a signal having a second protocol supported by a communications port of a user digital device.

28. A combined wireless transceiver and signal conversion unit as claimed in claim 16, wherein said input device is adapted to support a communications protocol of a communications port of a user digital device and convert the signal into one having a second protocol suitable for wireless communications between the transceiver and a receiver with which it is adapted to communicate.

29. A combined wireless radio transceiver and signal conversion unit as claimed in claim 16, wherein said transceiver is adapted to at least one of transmit and receive wireless signals having a frequency in the range of 2 GHz to 60 GHz.

30. A combined wireless radio receiver and signal conversion unit for use in a communication system, the unit comprising:
a radio receiver for receiving a wireless radio signal carrying digital data;
a converter for converting the received radio signal carrying digital data into a signal having a form which can be read by end use subscriber terminating equipment; and
an output device for outputting the converted signal.

31. A combined receiver/converter unit as claimed in claim 30, wherein the converter is arranged to convert the received radio signal into a signal contained in a frequency band above the audio frequency band allocated for voice channels on a telephone subscriber line.

32. A combined receiver/converter unit as claimed in claim 31, wherein the signal converter is adapted to convert the radio signal into a Digital Subscriber Line formatted signal.

33. A combined receiver/converter unit as claimed in claim 32, wherein the signal converter is adapted to convert the radio signal into any one or more of an ADSL, SDSL, HDSL, and VDSL formatted signal.

34. A combined receiver/converter unit as claimed in claim 30, wherein the output device is arranged to output the converted signal onto wiring of the type previously installed in a subscriber's premises capable of conveying communication signals.

35. A combined receiver/converter unit as claimed in claim 30, wherein the converter is adapted to output the converted signal onto at least one of a twisted-pair transmission line, an AC power line, a coaxial cable, a fibre for carrying optical signals and a local wireless communication channel.

36. A combined receiver/converter unit as claimed in claim 30, further comprising a monitoring device for monitoring a status of at least one of the radio receiver and the converter and for outputting a signal representative of the monitored status.

37. A combined receiver/converter unit as claimed in claim 36, wherein the output device is arranged to output the monitoring signal.

38. A combined receiver/converter unit as claimed in claim 30, wherein the wireless radio receiver is adapted to receive microwave radio signals in the range of 2 to 60 GHz.

39. A combined receiver/converter unit as claimed in claim 30 having a mounting for mounting the unit to structure on the outside of a building.

40. A combined receiver/converter unit as claimed in claim 30, further comprising a housing enclosing said receiver and converter.

41. A combined receiver/converter unit as claimed in claim 40, wherein said housing is adapted to prevent the ingress of moisture into the housing.

42. A combined wireless radio transmitter and signal conversion unit for use in a communication system comprising an interface device capable of reading communication signals having a form output from end user terminating equipment, and a wireless radio transmitter, the interface device being arranged to convert the received signal into a signal suitable for transmission by the transmitter, the transmitter being arranged to transmit the signal received from the interface device as a wireless radio signal.

43. A combined transmitter/converter unit as claimed in claim 42, in which the interface device is capable of reading a Digital Subscriber Line formatted signal.

44. A combined transmitter/converter unit as claimed in claim 42, wherein the interface device is connected to and receives the input signal on wiring which is previously installed in the subscriber's premises for transmitting electrical signals.

45. A combined transmitter/converter unit as claimed in claims 42, wherein the interface device is adapted for connection to at least one of a twisted-pair transmission line, an AC power line, a coaxial cable, a fiber for carrying optical signals and a local wireless communication channel.

46. A combined transmitter/converter unit as claimed in claim 42, wherein the radio transmitter is adapted to transmit radio signals having microwave frequencies in the range of 2 to 60 GHz.

47. A combined transmitter/converter unit as claimed in claim 42, having a mounting for mounting the unit to structure on the outside of a building.

48. A combined transmitter/converter unit as claimed in claim 42, further comprising a housing enclosing said interface device and transmitter.

49. A combined receiver/converter unit as claimed in claim 30, wherein said converter is adapted to support any one or more of DSL, Ethernet, local wireless, optical, IEEE-1394, ISDN, POTS, and IBM token ring communication protocols.

50. A combined transmitter/converter unit as claimed in claim 42, wherein said interface device is adapted to support any one or more of DSL, Ethernet, local wireless, optical, IEEE-1394, ISDN, POTS, and IBM token ring communication protocols.
